(19) United States
(12) Patent Application Publication
(10) Pub. No.: US 2015/0108821 A1
(43) Pub. Date: Apr. 23, 2015

(54) Leg Stabilizing Apparatus

(71) Applicant: Albert G. Smith, Warren, MI (US)

(72) Inventor: Albert G. Smith, Warren, MI (US)

(21) Appl. No.: 14/061,212

(22) Filed: Oct. 23, 2013

(51) Int. Cl. A61G 5/10

(52) U.S. Cl. CPC A61G 5/10
USPC 297/466

(57) ABSTRACT

An apparatus including a first member, a second member and a cross member. The first member has an upper end, a lower end, and a non-slip surface along at least a portion of an inner surface of the first member. The second member has an upper end, a lower end, and a non-slip surface along at least a portion of an inner surface of the second member. The cross member extends from the first member to the second member and retains the first member and the second member at a fixed distance relative to one another.

### TECHNICAL FIELD

This disclosure relates to a leg stabilizing apparatus for stabilizing the legs of a human.

### BACKGROUND

Many people encounter paralysis or partial paralysis of their legs. As a result of the loss of control of their legs, the legs may separate when a person is in the seated position. This may cause an uncomfortable situation for the person.

### SUMMARY

One aspect of the disclosure provides an apparatus including a first member, a second member and a cross member. The first member has an upper end, a lower end, and a non-slip surface along at least a portion of an inner surface of the first member. The second member has an upper end, a lower end, and a non-slip surface along at least a portion of an inner surface of the second member. The cross member extends from the first member to the second member and retains the first member and the second member at a fixed distance relative to one another.

Implementations of the disclosure may include one or more of the following features. In some implementations, the non-slip surfaces of the first and second members engage a first and second leg of a human. Additionally or alternatively, the non-slip surfaces of the first and second members may be fabricated from friction tape.

In some examples, the cross member includes a first cross member section and a second cross member section. The first cross member section has a depressible retaining pin at a distal end of the first cross member section. The second cross member section has a plurality of retention holes linearly extending from a distal end of the second cross member towards a proximate end of the second cross member section. The first cross member section is slidably positioned within the distal end of the second cross member section. Each of the plurality of receiving holes are configured to receive the retaining pin so as to correspond to a different fixed distance of the cross member.

In some implementations, the cross member includes a first cross member section having a distal end, a second cross member section having a threaded end, and a tightening nut. The distal end of the first cross member section is slidably inserted through the tightening nut and into the threaded end of the second cross member section. The tightening nut screws onto the threaded end and tightens the threaded end onto the first cross member section, thereby retaining the cross-member at a fixed distance. The cross member may include means for adjusting the fixed distance between the first and second member.

In some examples, the cross member includes a first cross member section and a second cross member section. The first cross member section is slidably inserted into the first cross member section. The apparatus may also include a strap extending from the lower end of the first member to the lower end of the second member. The strap may be adjustable in length.

Another aspect of the disclosure provides an apparatus including first means for engaging a first leg of a human, second means for engaging a second leg of a human, and a cross member. The cross member extends between the first means and the second means, and retains the first means and second means at a fixed distance apart. In some examples, the first means and the second means each include friction tape.

In some implementations, the cross member includes a first cross member section and a second cross member section. The first cross member section has a depressible retaining pin positioned at a distal end of the first cross member section. The second cross member section has a plurality of retention holes linearly extending from a distal end of the second cross member section towards a proximate end of the second cross member section. The first cross member section is slidably inserted into the distal end of the second cross member section. Each of the plurality of receiving holes are configured to receive the retaining pin so as to correspond to a different fixed distance of the cross member.

In some examples, the cross member includes a first cross member section having a distal end, a second cross member section having a threaded end, and a tightening nut. The distal end of the first cross member section is slidably inserted through the tightening nut and into the threaded end of the second cross member section. The tightening nut screws onto the threaded end and tightens the threaded end onto the first cross member section, thereby retaining the cross-member at a fixed distance. The cross member may include means for adjusting the fixed distance between the first means and the second means.

In some implementations, the cross member includes a first cross member section and a second cross member section. The first cross member section is slidably inserted into the first cross member section. The apparatus may further include a strap extending from the lower end of the first member to the lower end of the second member. Additionally or alternatively, a length of the strap may be adjustable.

Yet another aspect of the disclosure provides an apparatus including a first member, a second member, and a cross member. The first member has an upper end, a lower end, and a non-slip surface at least along an inner surface of the lower end of the first member. The second member has an upper end, a lower end, and a non-slip surface at least along an inner surface of the lower end of the second member. The cross member extends from the upper end of the first member to the upper end of the second member. The cross member holds the first member and the second member apart at a fixed distance. The cross member includes a first cross member section and a second cross member section. The second cross member section slidably receives the first cross member section such that the fixed distance is adjustable.

The apparatus may further include a tightening nut. The distal end of the first cross member section is slidably positioned through a center portion of the tightening nut and into a threaded end of the second cross member section. The tightening nut screws onto the threaded end and frictionally joins the threaded end onto the first cross member section, thereby retaining the cross-member to a fixed distance.

In some implementations, the first cross member includes a depressible retaining pin positioned at a distal end of the first cross member section. The second cross member section includes a plurality of retention holes linearly extending from a distal end of the second cross member section towards a proximate end of the second cross member section. The first cross member section slidably resides within the distal end of the second cross member section. Each of the plurality of receiving holes is sized to receive the retaining pin so as to correspond to a different fixed distance of the cross-member.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a drawing of a leg stabilizing apparatus in operation on a user.

FIG. 1B is an isometric view of the leg stabilizing apparatus according to some embodiments of the present disclosure.

FIGS. 2A and 2B are isometric views of the leg stabilizing apparatus according to some embodiments of the present disclosure.

FIG. 2C is an isometric view of the leg stabilizing apparatus according to some embodiments of the present disclosure.

FIGS. 3A and 3B are isometric views of the leg stabilizing apparatus according to some embodiments of the present disclosure.

FIG. 3C is an isometric view of the leg stabilizing apparatus according to some embodiments of the present disclosure.

Like reference symbols in the various drawings indicate like elements.

### DETAILED DESCRIPTION

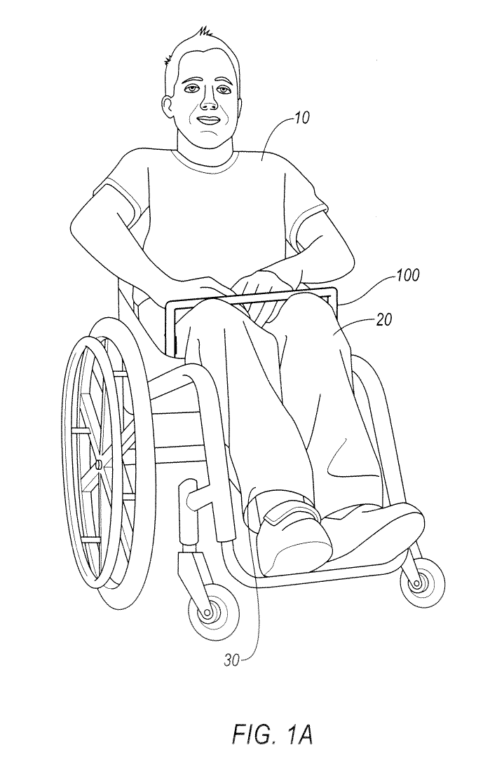

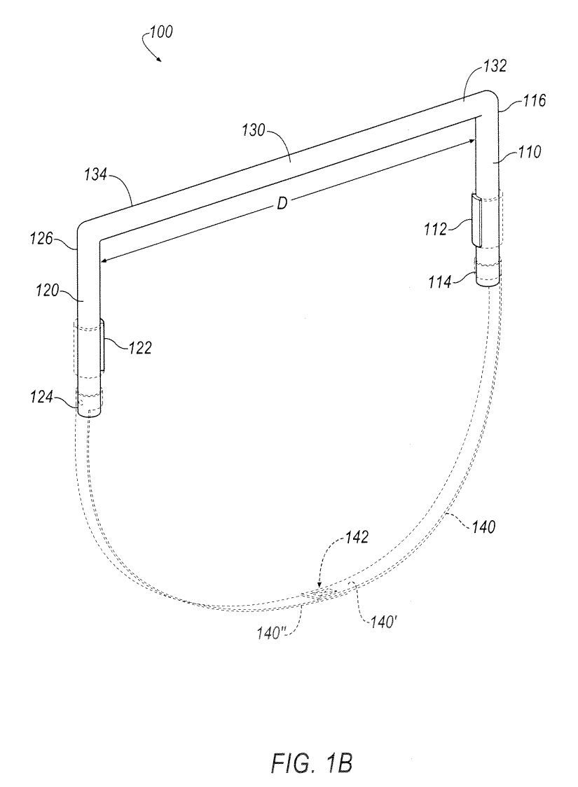

FIG. 1A illustrates a leg stabilizing apparatus 100 (the “stabilizing apparatus”) in operation on a user 10. The stabilizing apparatus 100 is placed around the legs 20, 30 of the user 10, thereby stabilizing the legs 20, 30 of the user 10. In this way, the user 10 does not have to worry about his/her legs 20, 30 separating at inappropriate times (e.g., while in public). The stabilizing apparatus 100 is particularly useful to those suffering from afflictions that reduce the dexterity in their hands (e.g., multiple sclerosis), as the stabilizing apparatus 100 can be easily slid onto and off of the lap of the user 10.

FIG. 1B is an embodiment of a leg stabilizing apparatus 100. In the example of FIG. 1B, the stabilizing apparatus 100 includes a first member 110, a second member 120, and a cross member 130. The first member 110 and the second member 120 may respectively include non-slip surfaces 112, 122. In some embodiments, the stabilizing apparatus 100 may include an adjustable strap 140 that connects the lower portion 114 of the first member 110 and a lower portion 124 of the second member 120.

The first member 110, the second member 120, and the cross member 130 may be fabricated from any suitable material, such as PVC pipe, aluminum tubing, or the like. In some embodiments, the first member 110, the second member 120, and the cross member 130 are made of high density molded plastic. The first member 110, the second member 120, and the cross member 130 may be formed by way of any desirable forming technique, such as injection molding, insert molding, or the like. In some embodiments, the upper portion 116 of the first member 110 and a first end 132 of the cross member 130 are continuously formed together (i.e., without joints or seams), thereby forming a substantially orthogonal connection (e.g., between 75 and 105 degrees). Similarly, the upper portion 126 of the second end 120 and a second end 134 of the cross member 130 are continuously formed together, thereby forming a substantially orthogonal connection. In some embodiments, the respective upper portions 116 and 126 and the respective ends 132 and 134 of the cross member 130 are joined using elbow joint connectors (not shown) or the like.

The first non-slip surface 112 and the second non-slip surface 122 increase the friction between the apparatus 100 and the legs 20, 30 of a user 10. In some embodiments, the non-slip surfaces 112, 122 are non-abrasive, so as to not irritate the skin of the user 10 or abrade the clothing of the user 10. At the same time, the non-slip surfaces 112, 122 should provide enough friction to keep the apparatus 100 from slipping off of the lap of the user 10. The non-slip surfaces 112, 122 can be located at an interior portion of the respective first and second members 110, 120 (i.e., the non-slip surfaces 112, 122 are facing one another). Additionally, the non-slip surfaces 112, 122 can extend partially or completely around the first member 110 and the second member 120. In some embodiments, the non-slip surfaces 112, 122 can be applied to the first member 110 and the second member 120. In these embodiments, the non-slip surfaces 112, 122 can be made of friction tape or insulation tape. A strip of the tape may be adhered to the inner surfaces of the first member 110 and the second member 120 or can be wrapped around the first member 110 and the second member 120. In other embodiments, the non-slip surfaces 112, 122 are comprised of friction paint, rubber, foam, or any other material that increases the friction of coefficient of the non-slip surfaces 112, 122. In some embodiments, the non-slip surfaces 112, 122 are integrally formed into the first and second member 110, 120. For instance, the non-slip surfaces 112, 122 may be comprised of hundreds or thousands of minute raised surfaces (a few micrometers in height) which serve to increase the friction of coefficient of friction of the non-slip surfaces 112, 122.

As shown, the cross member 130 is a single bar that extends from the first member 110 to the second member 120. The cross member 130 holds the first member 110 and the second member 120 apart at a fixed distance D. In the illustrated example of FIG. 1B, the fixed distance cannot be adjusted. As will be described in greater detail below, in some embodiments, the cross member 130 can be extended and retracted to accommodate the statures of different users 10.

In some embodiments, the apparatus 100 includes a strap 140. The strap 140 can provide additional support and can tighten the fit of the apparatus 100 around the legs 20, 30 of the user 10. In some embodiments, the strap 140 uses hook and loop fasteners (e.g., Velcro® to connected/disconnect the ends 140′ and 140″ of the strap 140). The user 10 can slide the apparatus 100 into his or her lap and can then adjust the length of the strap 140 to a desired length, such that the apparatus 100 snugly fits around the legs 20, 30 of the user 10. Other types of strap connecting/disconnection systems may be used as well.

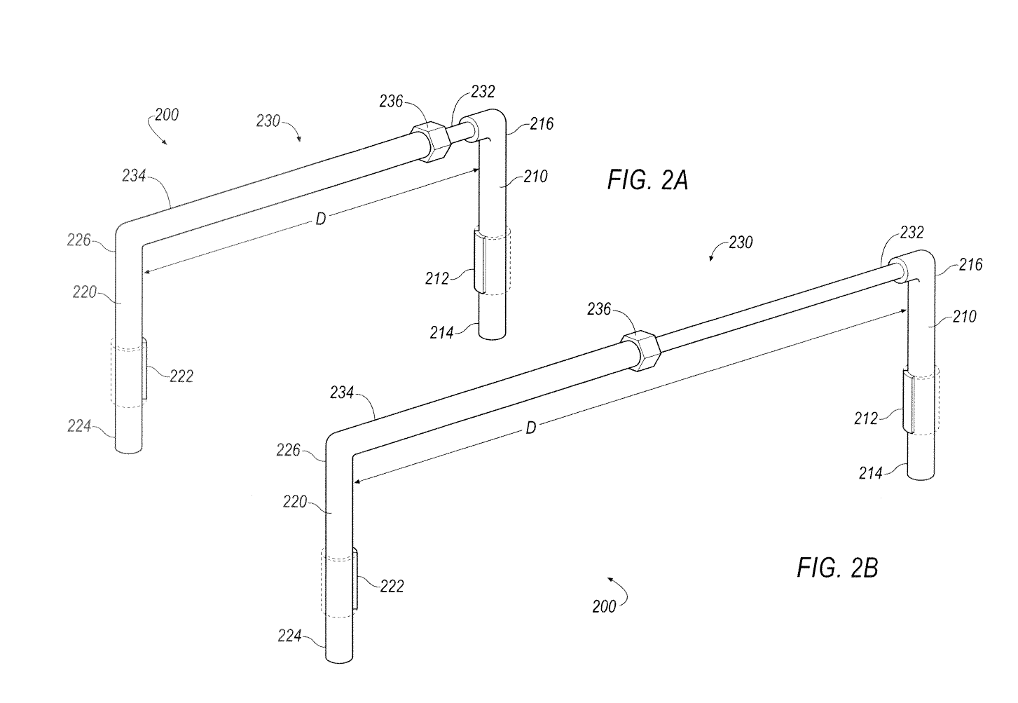

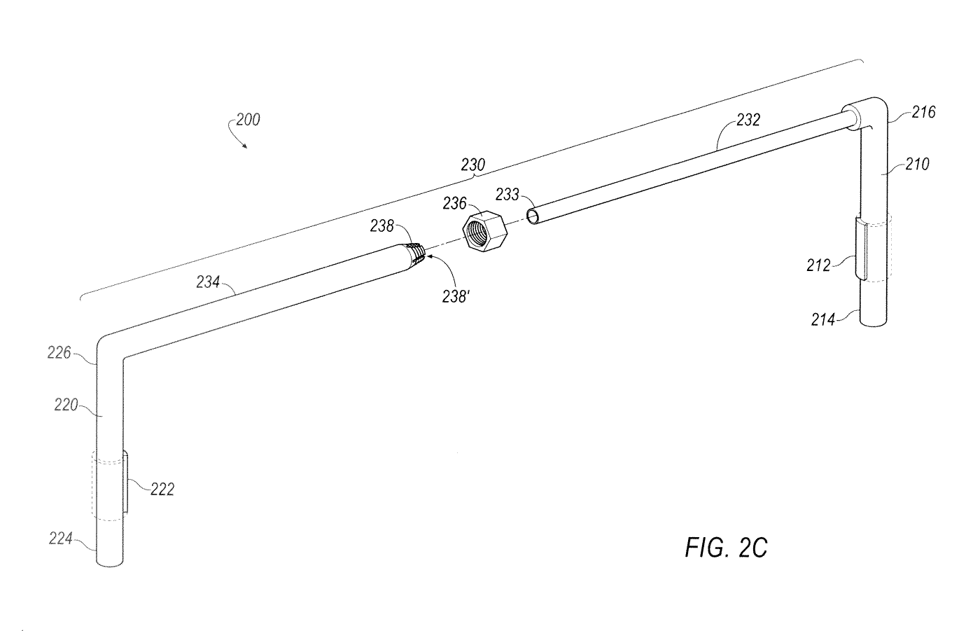

Referring now to FIGS. 2A-2C, another example of a stabilizing apparatus 200 is illustrated. The stabilizing apparatus 200 includes a first member 210, a second member 220, and a cross member 230. In the illustrated example, the first member 210 and the second member 220 may be similar to the first and second members 110, 120 described with respect to FIG. 1B and can include non-slip surfaces 212, 222, as described above.

In the embodiments of FIGS. 2A-2C, the cross member 230 is comprised of telescoping sections, such that the length of the cross member 230 is adjustable. In these embodiments, the cross member 230 includes a first cross member section 232, a second cross member section 234, and a tightening nut 236. The second cross member section 234 and the tightening nut 236 form a collet around the first cross member section 232. The second cross member section 234 has a threaded distal end 238 on which the tightening nut 236 screws. The threaded distal end 238 is tapered and can be fitted with one or more slotted openings 238′. The first cross member section 232 has a smaller diameter than the inner diameter of the second cross member section 234. The second cross member section 234 telescopically receives a distal end 233 of the first cross member section 232. The first cross member section 232 is slidably inserted through the tightening nut 236 into the second cross member section 234. In this way, the length of the cross member 230 can be increased or decreased by sliding the first cross member section 232 out of or further into the second cross member section 234. When the length of the cross member 230 is a desirable length, the user 10 (or any other person) can twist the tightening nut 236 onto the distal end 238 of the second cross member section 234. The second cross member section 234 is fitted with tapered threads that are adapted to engage mating tapered threads fashioned into the tightening nut 236. As the tightening nut 236 is tightened on the distal end 238, the distal end 238 is forcibly compressed against the first cross member section 232, thereby frictionally fixing the first and second cross members 232, 234 to one another. In this way, the distance D between the first member 210 and the second member 220 is fixed.

It is noted that the configuration of FIGS. 2A-2C is provided for example only. Other means for tightening the grip onto the first cross member section 232 and the second cross member section 234 can be implemented as well. For example, any suitable collet assembly may be used in place of the tightening nut 236 collet assembly described above.

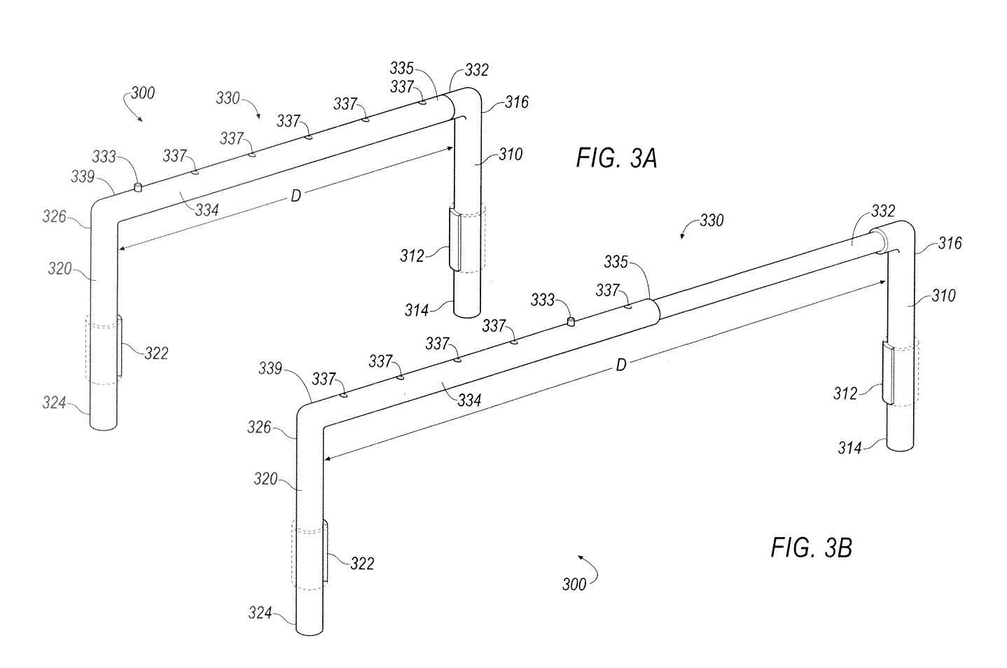

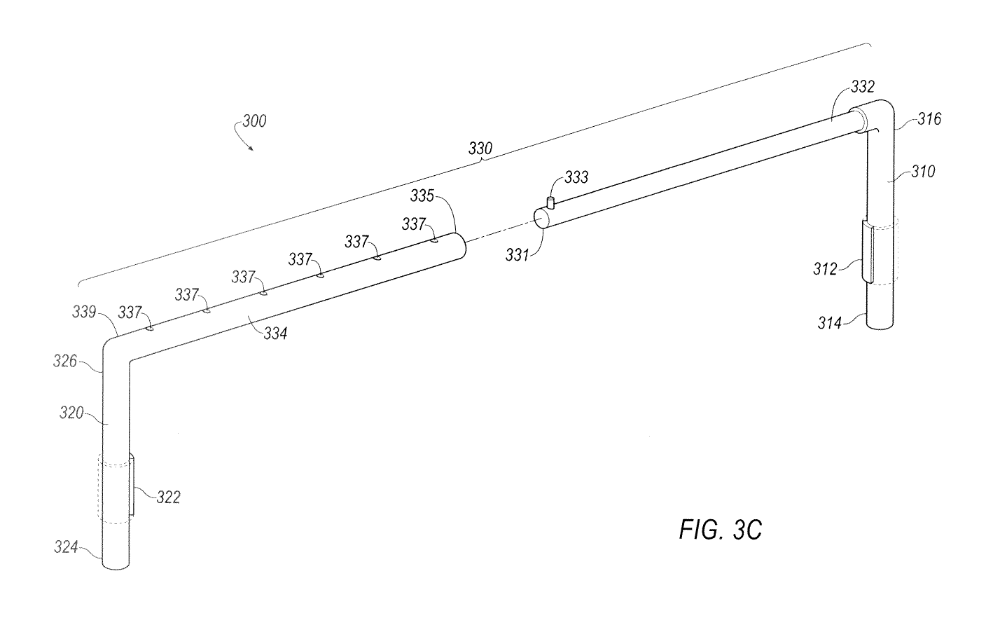

Referring now to FIGS. 3A-3C, another example of a stabilizing apparatus 300 is illustrated. The stabilizing apparatus 300 includes a first member 310, a second member 320, and a cross member 330. In the illustrated example, the first member 310 and the second member 320 may be similar to the first and second members 110, 120 described with respect o FIG. 1B and can include non-slip surfaces 312 and 322, as described above.

In the embodiments of FIGS. 3A-3C, the cross member 330 is telescoping, such that the length of the cross member 330 is adjustable. In these embodiments, the cross member 330 includes a first cross member section 332 and a second cross member section 334 that receives the first cross member section 332.

In the illustrated example, the first cross member section 332 includes a retaining pin 333 located at a distal end 331 of the first cross member section 332. The retaining pin 333 may be urged outwardly by a spring and can be forcibly pressed into the body of the first cross member section 332.

The second cross member section 334 has an inner diameter that is slightly larger than the first cross member section 332. A plurality of registration holes 337 are displaced along the surface of the second cross member section 334. The registration holes 337 are sized large enough to receive the retaining pin 333. In the illustrated example, there are six registration holes 337 extending from the distal end 335 of the second cross member section 334 to the proximate end 339 of the second cross member section 334. While the illustrated embodiment shows six registration holes 337 disposed along the surface of the second cross member section 334, the second cross member section 334 can include any reasonable number of registration holes 337.

In operation, the user can press the retaining pin 333 into the first cross member section 332 and slide the first cross member section 332 with respect to the second cross member section 334. When the cross member 330 is at a desired length, the user can lock the retaining pin 333 into the nearest registration hole 337, thereby fixing the distance D between the first member 310 and the second member 320.

A number of embodiments have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. An apparatus comprising:
a first member having an upper end, a lower end, and a non-slip surface along at least a portion of an inner surface of the first member;
a second member having an upper end, a lower end, and a non-slip surface along at least a portion of an inner surface of the second member; and
a cross member extending from the first member to the second member, the cross member retaining the first member and second member at a fixed distance relative to one another.

2. The apparatus of claim 1, wherein the non-slip surfaces of the first and second members engage a first and second leg of a human.

3. The apparatus of claim 2, wherein the non-slip surfaces of the first and second members are fabricated from friction tape.

4. The apparatus of claim 1, wherein the cross member includes:
a first cross member section having a depressible retaining pin positioned at a distal end of the first cross member section: and
a second cross member section having a plurality of retention holes linearly extending from a distal end of the second cross member section towards a proximate end of the second cross member section, the first cross member section being slidably positioned within the distal end of the second cross member section and each of the plurality of receiving holes being configured to receive the retaining pin so as to correspond to a different fixed distance of the cross member.

5. The apparatus of claim 1, wherein the cross member includes:
a first cross member section having a distal end;
a second cross member section having a threaded end,
a tightening nut, wherein the distal end of the first cross member section is slidably inserted through the tightening nut and into the threaded end of the second cross member section, wherein the tightening nut screws onto the threaded end and tightens the threaded end onto the first cross member section, thereby retaining the cross-member at a fixed distance.

6. The apparatus of claim 1, wherein the cross member includes means for adjusting the fixed distance between the first and second member.

7. The apparatus of claim 1, wherein the cross member includes:
a first cross member section; and
a second cross member section, the first cross member section being slidably inserted into the first cross member section.

8. The apparatus of claim 1, further comprising a strap extending from the lower end of the first member to the lower end of the second member.

9. The apparatus of claim 1, wherein the strap is adjustable in length.

10. An apparatus comprising:
first means for engaging a first leg of a human;
second means for engaging a second leg of a human; and
a cross member extending between the first means and the second means and retaining the first means and second means at a fixed distance apart.

11. The apparatus of claim 10, wherein the first means and the second means each include friction tape.

12. The apparatus of claim 10, wherein the cross member includes:
a first cross member section having a depressible retaining pin positioned at a distal end of the first cross member section; and
a second cross member section having a plurality of retention holes linearly extending from a distal end of the second cross member section towards a proximate end of the second cross member section, the first cross member section being slidably inserted into the distal end of the second cross member section and each of the plurality of receiving holes being configured to receive the retaining pin so as to correspond to a different fixed distance of the cross-member.

13. The apparatus of claim 10, wherein the cross member includes:
a first cross member section having a distal end;
a second cross member section having a threaded end,
a tightening nut, wherein the distal end of the first cross member section is slidably inserted through the tightening nut and into the threaded end of the second cross member section, wherein the tightening nut screws onto the threaded end and tightens the threaded end onto the first cross member section, thereby retaining the cross-member at a fixed distance.

14. The apparatus of claim 10, wherein the cross member includes means for adjusting the fixed distance between the first means and the second means.

15. The apparatus of claim 10, wherein the cross member includes:
a first cross member section; and
a second cross member section, the first cross member section being slidably inserted into the first cross member section.

16. The apparatus of claim 10, further comprising a strap extending from the lower end of the first member to the lower end of the second member.

17. The apparatus of claim 16, wherein a length of the strap is adjustable.

18. An apparatus comprising:
a first member having an upper end and a lower end, the first member having a non-slip surface at least along an inner surface of the lower end of the first member;
a second member having an upper end and a lower end, the second member having a non-slip surface at least along an inner surface of the lower end of the second member; and
a cross member extending from the upper end of the first member to the upper end of the second member, the cross member holding the first member and second member apart at a fixed distance, the cross member including a first cross member section and a second cross member section, the second cross member section slidably receiving the first cross member section such that the fixed distance is adjustable.

19. The apparatus of claim 18, further comprising:
a tightening nut,
wherein a distal end of the first cross member section is slidably positioned through a center portion of the tightening nut and into a threaded end of the second cross member section, and
wherein the tightening nut screws onto the threaded end and frictionally joins the threaded end onto the first cross member section thereby retaining the cross-member to a fixed distance.

20. The apparatus of claim 18, wherein:
the first cross member section includes a depressible retaining pin positioned at a distal end of the first cross member section; and
the second cross member section includes a plurality of retention holes linearly extending from a distal end of the second cross member section towards a proximate end of the second cross member section, the first cross member section slidably residing within the distal end of the second cross member section and wherein each of the plurality of receiving holes being sized to receive the retaining pin so as to correspond to a different fixed distance of the cross-member.
